(19) United States
(12) Patent Application Publication
(10) Pub. No.: US 2008/0043368 A1
(43) Pub. Date: Feb. 21, 2008

(54) Disk apparatus

(75) Inventor: Yasuichi Hashimoto, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/812,800

(22) Filed: Jun. 21, 2007

(30) Foreign Application Priority Data
Jun. 27, 2006 (JP) 2006-176778

(51) Int. Cl. G11B 17/08; G11B 17/02

(52) U.S. Cl. 360/98.07; 360/99.08

(57) ABSTRACT

According to one embodiment, a recording medium, a drive motor which supports and rotates the recording medium, heads, and a head actuator are arranged in a case of a disk apparatus. The drive motor includes a rotor rotatably supported by a fluid bearing and a stator arranged at an outer periphery of the rotor in a circumferential direction and having a plurality of magnetic poles confronting with magnetic poles of the rotor. The stator includes a removed portion which is located on a moving path of the heads and in which magnetic poles are removed in a range corresponding to 25% or less of the entire angle of 360° of the stator in the circumferential direction, a plurality of stator magnetic poles arranged at intervals in the circumferential direction except the removed portion, and a magnet attraction plate arranged in the removed portion and opposed to the rotor.

### CROSS-REFERENCE TO RELATED APPLICATIONS

This application is based upon and claims the benefit of priority from Japanese Patent Application No. 2006-176778, filed Jun. 27, 2006, the entire contents of which are incorporated herein by reference.

### BACKGROUND

1. Field

One embodiment of the present invention relates to a disk apparatus having a disk as a recording medium.

2. Description of the Related Art

Recently, disk apparatuses such as a magnetic disk apparatus and an optical disk apparatus are widely used as an external recording apparatus of a computer and as an apparatus for recording/replaying music and images.

For example, a magnetic disk apparatus ordinarily includes a magnetic disk, a spindle motor for supporting and driving the magnetic disk in rotation, a head actuator supporting magnetic heads, a voice coil motor for driving the head actuator, a circuit substrate unit and the like arranged in a case. The head actuator includes a bearing unit attached to the case and a plurality of arms supported on the bearing unit and extending therefrom, and each of heads is attached to the arm through a suspension.

The case includes a base having an upper surface opened and the plurality of above mechanism units mounted thereon and a top cover covering the opening of the base. Ordinarily, the top cover is fixed to the peripheral edge of the upper surface of the base by a plurality of screws.

In general, the spindle motor includes a rotor rotatably supported by a bearing and an annular stator arranged on the base and located around the rotor in confrontation with the periphery thereof. For example, the rotor includes a permanent magnet having a plurality of magnetic poles, the stator includes a plurality of magnetic poles each formed of a coil wound around an iron core, and these magnetic poles are arranged around the entire periphery of the rotor with equal intervals in the circumferential direction thereof.

Recently, as a magnetic disk apparatus is reduced in size, a magnetic disk itself and the mechanism units thereof are also reduced in size. However, a spindle motor cannot be made smaller than a certain degree for convenience of accuracy and performance. Accordingly, in a small magnetic disk apparatus, the outer peripheral edge of the stator is generally made considerably larger than the size of the inner periphery of a magnetic disk. Further, when it is intended to make a disk apparatus thin in its entirety, the gap between a magnetic disk and the stator must be reduced.

In such a case, unless there is no space, in which a magnetic head is moved, between the magnetic disk and a motor, the magnetic head cannot move up to the inner peripheral portion of the magnetic disk. Accordingly, since the moving range of the magnetic head is reduced, an area in the magnetic disk, which can be used for recording and reproducing, is greatly reduced. As a result, it is difficult to effectively utilize the recording capacity of the magnetic disk. On the contrary, when the gap between the magnetic disk and the stator is increased in a height direction to permit movement of the magnetic head, it prevents reduction of thickness of the magnetic disk apparatus.

To cope with the above problems, Jpn. Pat. Appln. KOKAI Publication No. 2003-61304, for example, proposes a small magnetic disk apparatus in which a large moving range of a magnetic head is secured by removing a portion in a stator corresponding to the moving range of the magnetic head. According to the apparatus, it is possible to move the magnetic head up to the inner periphery of a magnetic disk without increasing the gap between the magnetic disk and the stator in the height direction thereof. With this arrangement, it is possible to reduce the thickness of the apparatus and to improve the recording capacity thereof.

However, recently, a small magnetic disk apparatus generally employs a fluid bearing as a bearing for supporting a rotor to reduce noise of a spindle motor. The fluid bearing has such a structure that it supports a shaft with a fluid filled around the periphery of the shaft without being provided with solid balls for mechanically supporting the shaft different from a ball bearing. For this reason, when a structure, in which a part of a stator is removed as described above and magnetic poles are not equally arranged in a circumferential direction, there is caused a phenomenon in that the shaft of the rotor is rotated out of a center because the rotor has an attraction force different from that of the stator and a phenomenon in that the shaft of the rotor is rotated in a fallen state. In this case, the recording accuracy and the reading accuracy of a magnetic head with respect to a magnetic disk are deteriorated.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing an HDD according to a first embodiment of the present invention;

FIG. 2 is an exemplary sectional view showing the HDD;

FIG. 3 is an exemplary plan view showing a head actuator of the HDD and a stator of a spindle motor;

FIG. 4 is an exemplary sectional view of the spindle motor taken along the line IV-IV of FIG. 3;

FIG. 5 is an exemplary plan view showing a metal sheet constituting a core of the stator;

FIG. 6 is an exemplary sectional view showing an HDD according to a second embodiment of the present invention;

FIG. 7 is an exemplary perspective view showing a core of a spindle motor in the HDD according to the second embodiment;

FIG. 8 is an exemplary plan view showing a base metal sheet forming the core; and

FIG. 9 is an exemplary plan view showing a lamination metal sheet for forming the core.

### DETAILED DESCRIPTION

Various embodiments according to the invention will be described hereinafter with reference to the accompanying drawings. In general, according to one embodiment of the invention, there is provided a disk apparatus comprises: a case having a base; a disk-shaped recording medium arranged in the case; a drive motor which rotates the recording medium, the drive motor being arranged on the base and supporting the recording medium; heads which record and replay information to and from the recording medium; and a head actuator which moves the heads with respect to the recording medium, the head actuator being arranged in the case and movably supporting the heads. The drive motor includes: a rotor having a plurality of magnetic poles arranged side by side in a circumferential direction; a fluid bearing rotatably supporting the rotor; and a stator arranged at an outer periphery of the rotor in a circumferential direction and having a plurality of magnetic poles in confrontation with the magnetic poles of the rotor. The stator includes: a removed portion which is located on a moving path of the heads and in which magnetic poles are removed in a range corresponding to 25% or less of the entire angle of 360° of the stator in the circumferential direction; a plurality of stator magnetic poles arranged at intervals in the circumferential direction except the removed portion; and a magnet attraction plate arranged in the removed portion and opposed to the rotor.

A first embodiment, in which a disk apparatus of the present invention is applied to a hard disk drive (hereinafter, referred to as HDD), will be described in detail with reference to the accompanying drawings.

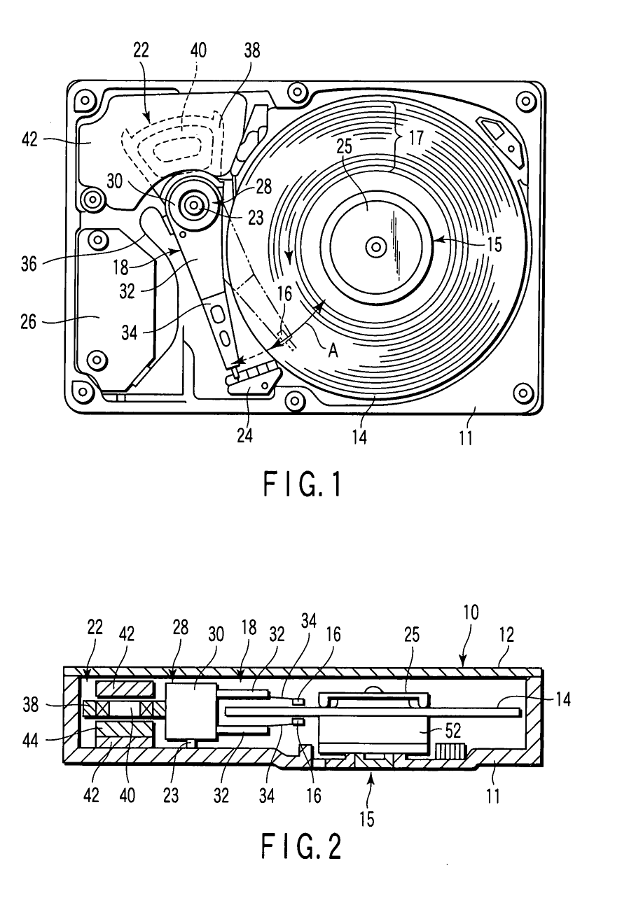

As shown in FIGS. 1 and 2, the HDD includes a case 10. The case 10 includes a rectangular box-shaped base 11 having an upper surface opened and a rectangular plate-shaped top cover 12, and the top cover is fixed to the base by a plurality of screws and closes the upper end opening of the base. With this configuration, the interior of the case 10 is kept air tight and can be ventilated to the outside through only a breathing filter (not shown). The base 11 and the top cover 12 are formed of, for example, iron.

Arranged on the base 11 are a magnetic disk 14 as a recording medium, a spindle motor 15, a plurality of magnetic heads 16, for example, two magnetic heads 16, a head actuator 18, and a voice coil motor (hereinafter, referred to as VCM) 22. The spindle motor 15 supports and rotates the magnetic disk. The magnetic heads 16 record and reproduce information to and from the magnetic disk. The head actuator 18 supports these magnetic heads 16 so that they are movable with respect to the surfaces of the magnetic disk 14. The VCM 22 rotates and positions the head actuator 18. Further, arranged on the base 11 are a lamp load mechanism 24, an inertia latch mechanism (not shown) and a flexible printed circuit board unit (hereinafter, referred to as FPC unit) 26. The lamp load mechanism 24 holds the magnetic heads 16 at positions spaced apart from the magnetic disk 14 when the magnetic heads 16 move to the outermost periphery of the magnetic disk. The inertia latch mechanism holds the head actuator 18 at an evacuating position when a shock and the like are applied to the HDD. The FPC unit 26 has electronic parts such as a preamplifier mounted thereon.

A printed circuit board (not shown) is fixed on the outside surface of the base 11 by screws and opposed to the bottom wall of the base 11. The printed circuit board controls the operations of the spindle motor 15, the VCM 22, and the magnetic heads through the FPC unit 26.

The magnetic disk 14 is formed to have a diameter of, for example, about 22 mm (0.85 inch) and has magnetic recording layers on the upper and lower surfaces thereof. The magnetic disk 14 is fitted to a hub of the spindle motor 15 to be described later coaxially therewith as well as clamped by a clamp spring 25 and fixed to the hub. The magnetic disk 14 is rotated by the spindle motor 15 as a drive motor at a predetermined speed of, for example, 3600 rpm.

The head actuator 18 includes a bearing assembly 28 fixed on the bottom wall of the base 11. The bearing assembly 28 acting as a bearing unit has a shaft 23 standing on the bottom wall of the base 11 and a cylindrical hub 30 rotatably supported by the shaft through a pair of bearings. The head actuator 18 has two arms 32 attached to the hub 30, two suspensions 34 extending from the respective arms, the magnetic heads 16 supported on the extended ends of the suspensions, and a plurality of spacer rings.

Each of the magnetic heads 16 includes an approximately rectangular slider (not shown) and a recording/replaying magneto resistance (MR) head device formed to the slider, and is fixed to a gimbal portion formed at the extreme end of the suspension 34. The magnetic heads 16 are electrically connected to a main FPC 36 to be described later through unillustrated relay flexible printed circuit boards (hereinafter, referred to as relay FPCs). The relay FPCs are bonded on the surfaces of the arms 32 and the suspensions 34 of the head actuator 18 and extend from the extreme ends of the suspensions to the turning base ends of the arms. The relay FPCs are formed to a slender strip shape in their entireties, and the extreme ends thereof are electrically connected to the magnetic heads 16 as well as the base end portions thereof are electrically connected to the main FPC 36. With this configuration, the magnetic heads 16 are electrically connected to the FPC unit 26 through the relay FPCs and the main FPC 36.

The two arms 32 fitted to the outer periphery of the hub 30 are located in parallel with each other at a predetermined interval, and the suspensions 34 and the magnetic heads 16 attached to these arms are located to confront with each other through the magnetic disk 14. The VCM 22 has a support frame 38 extending from the hub 30 in a direction opposite to the arms 32 and a voice coil 40 supported by the support frame. With the head actuator 18 assembled to the base 11, the voice coil 40 is located between a pair of yokes 42 fixed on the base 11 and constitutes the VCM 22 together with these yokes and a magnet 44 fixed to one of the yokes.

When the voice coil is energized in a state that the magnetic disk 14 is rotated, the head actuator 18 is turned, and the magnetic heads 16 are moved to and positioned on desired tracks 17 of the magnetic disk 14. At the time, the magnetic heads 16 are moved between an inner peripheral edge portion and an outer peripheral edge portion of the magnetic disk 14 along a radial direction thereof as shown by an arrow A of FIG. 1. One of the magnetic heads 16 is moved between one surface of the magnetic disk 14 and the top cover 12, and the other magnetic head 16 is moved between the other surface of the magnetic disk and the inner surface of the base 11.

Next, the spindle motor 15 will be explained.

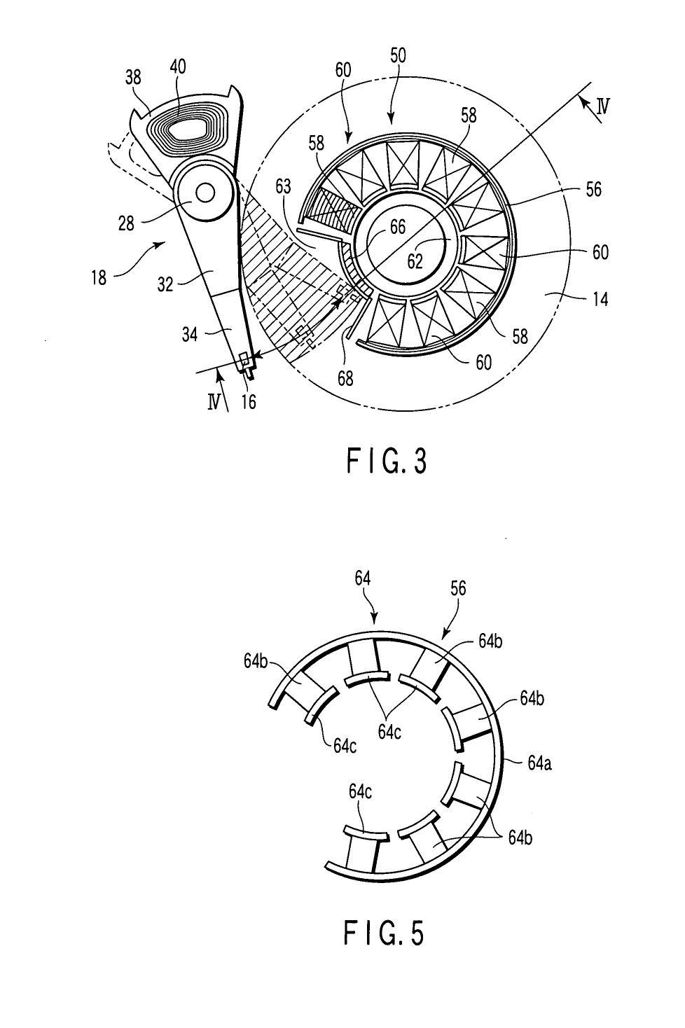

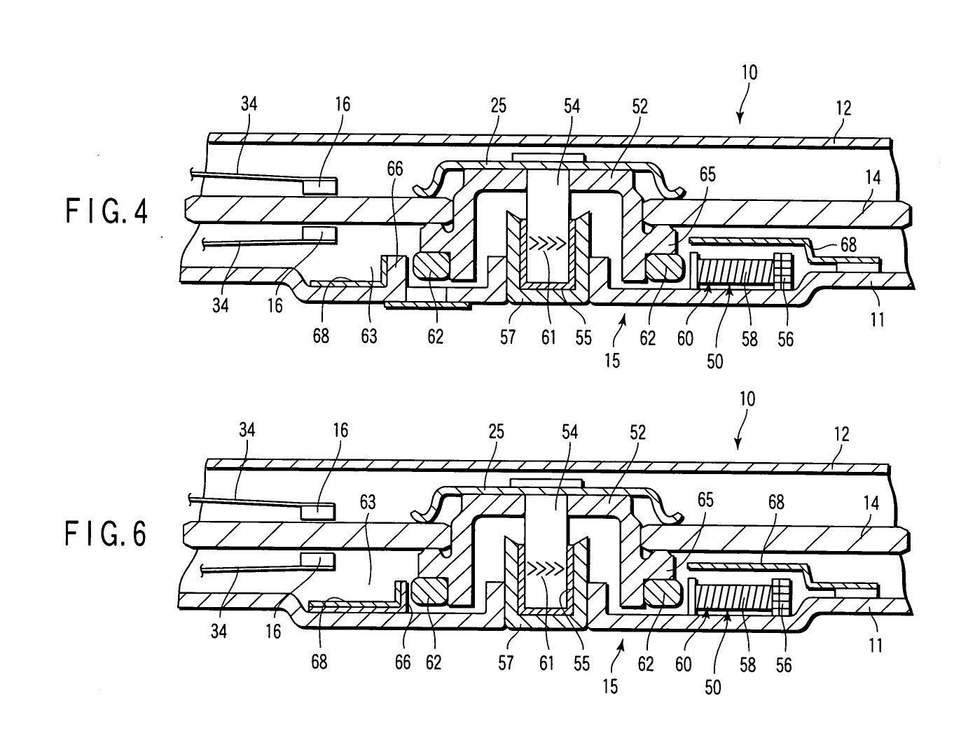

FIG. 3 shows a stator 50 of the spindle motor 15 and the head actuator 18, and FIG. 4 shows a cross section of the spindle motor.

As shown in FIGS. 3 and 4, the spindle motor 15 includes a rotor as a rotating member and the stator 50 as a fixed member. As described above, the spindle motor 15 includes a hub 52 acting as the rotor and a spindle shaft 54 fixed to the hub. The hub 52 is formed to a cylindrical shape with its upper end closed. The spindle shaft 54 is fixed to the upper end of the hub and extends coaxially with the hub. The spindle shaft 54 is rotatably supported by a fluid bearing 55 with respect to the base 11.

The fluid bearing 55 has a cylindrical bearing sleeve 57 fixed to the base 11. The lower end of the spindle shaft 54 is inserted into the bearing sleeve 57 through a minute interval on the outside surface side thereof. A gap between the inside surface of the bearing sleeve 57 and the outside surface of the spindle shaft 54 is filled with a fluid, for example, a lubricant. Further, formed on the outside surface of the spindle shaft 54 are a dynamic pressure generation groove, for example, a herringbone-shaped groove 61, which generates dynamic pressure in a radial direction by the spindle shaft 54 when it rotates, and another dynamic pressure generation groove (not shown) which generates dynamic pressure in a thrust direction.

An annular magnet 62 is fixed on the outer peripheral surface of the hub 52 at the lower end thereof and located coaxially with the spindle shaft 54. The magnet 62 has a plurality of N poles and S poles which are alternately formed along a circumferential direction at equal intervals. An annular flange 65 is formed on the outer peripheral surface of the hub 52 at an intermediate portion thereof integrally therewith. Further, the magnetic disk 14 is fitted around the periphery of the hub 52 coaxially therewith and abutted on the flange 65.

The stator 50 is formed approximately annularly except a removed portion 63 as described below. The stator 50 is fixed on the base 11 coaxially with the spindle shaft 54 and located in confrontation with the outside of the hub 52. The stator 50 includes a core 56 formed by laminating a plurality of metal sheets 64 and a plurality of coils 58 wound around the core. A plurality of magnetic poles 60 are formed of the cores and the coils. These magnetic poles 60 are arranged in the circumferential direction at equal intervals in confrontation with the magnetic poles of the magnet 62.

The stator 50 is located on moving paths of the magnetic heads 16 as well as has the removed portion 63 in which magnetic poles are removed in a range corresponding to 25% or less with respect to the entire angle of 360° in the circumferential direction, that is, in a range corresponding to 90° or less. The magnetic poles 60 of the stator 50 are arranged in the circumferential direction at approximately equal intervals except the removed portion 63. In the embodiment, the removed portion 63 is formed to a range of 65° with respect to the entire circumference of 360° of the stator 50.

FIG. 5 shows a metal sheet 64 constituting the core 56. The metal sheet 64 includes an arc-shaped frame portion 64a, a plurality of coil support portions 64b extending from the frame portion toward the center thereof, and arc-shaped locking portions 64c formed to the extending ends of the respective support portions. The frame portion 64a is formed to an arc shape from which a circumferential portion corresponding to the removed portion 63 is removed so that it is partially opened. The metal sheet 64 is formed of a magnetic material, for example, iron.

The core 56 is formed by laminating a plurality of metal sheets 64, for example, four metal sheets 64. Then, the coils 58 are wound around the laminated portions of the respective coil support portions 64b. With the stator 50 mounted on the base 11, the respective locking portions 64c of the core 56 confront with the outer peripheral surface of the magnet 62 in the vicinity thereof.

As shown in FIGS. 3 and 4, the spindle motor 15 has a magnetic attraction plate 66 arranged in the removed portion 63 of the stator 50 in confrontation with the outer peripheral surfaces of the hub 52 and the magnet 62 in the vicinities thereof. The magnetic attraction plate 66 is formed by cutting and raising a part of the base 11 toward the inside of the case 10. The magnetic attraction plate 66 is formed to an arc-shape and arranged on the concentric circle of the respective locking portions 64c of the core 56 constituting the stator 50. As described later, the magnetic attraction plate 66 generates attraction force between the magnet 62 and the stator 50 in the removed portion 63 of the stator 50 likewise in the other portion to thereby maintain stable rotation of the rotor by reducing a difference of attraction force.

The spindle motor 15 includes a magnetic shield plate 68 covering the outside surface of the stator 50 except that portion of the stator which opposes to the magnet 62. The magnetic shield plate 68 is formed of, for example, Permalloy. The magnetic shield plate 68 covers also the outer peripheral surface of the magnetic attraction plate 66 and both the ends of the removed portion 63.

According to the HDD configured as described above, the portion of the stator 50 of the spindle motor 15, which is located on the moving path of the lower magnetic head 16, that is, on the magnetic head 16 interposed between the magnetic disk 14 and the base 11 is removed, thereby the removed portion 63 is formed. Therefore, even if the HDD is formed thin in its entirety, the movement of the magnetic heads 16 is not prevented by the stator 50, and a sufficient moving range of the magnetic heads can be secured. With this configuration, the region of the magnetic disk 14 up to the inner circumferential edge thereof can be used to record and replay information, so that the recording capacity of the magnetic disk can be effectively utilized.

At the time, the magnetic attraction plate 66 is arranged at the removed portion 63 of the stator 50 and opposed to the magnet 62 in the vicinity thereof. Accordingly, the attraction force between the magnet 62 and the stator 50 can be generated likewise the other portion, and thus the difference of the attraction force in the circumferential direction of the stator 50 can be reduced. As a result, even if the stator 50 is provided with the removed portion 63, the stable rotation of the rotor can be maintained. Further, the magnetic attraction plate 66 can be easily formed by making use of a part of the base 11.

It is possible from the configuration described above, to obtain a disk apparatus which is formed small and thin in size and can stably drive a disk.

Although the magnetic attraction plate 66 of the first embodiment described above is formed of a part of the base 11, it is not limited thereto. That is, according to an HDD of a second embodiment of the present invention, a magnetic attraction plate 66 is configured by bending a part of a core as shown in FIGS. 6 to 9.

To describe this configuration in more detail, the core 56 of a stator 50 is configured by laminating a plurality of metal sheets, for example, four metal sheets. The core 56 is formed by overlapping three lamination metal sheets 64 shown in FIG. 9 on a base metal sheet 70 shown in FIG. 8.

The base metal sheet 70 includes an annular frame portion 70a, a plurality of coil support portions 70b extending from the frame portion toward the center thereof, and arc-shaped locking portions 70c formed at the extended ends of the coil support portions integrally therewith. A plurality of coil support portions 70b, for example, nine coil support portions 70b are arranged in a circumferential direction of the frame portion 70a at equal intervals. Two adjacent locking portions 70c of the plurality of locking portions 70c extend more than the other locking portions toward the center of the frame portion 70a to thereby form extending portions 70d. As described below, the extending portions 70d are bent at right angles with respect to coil support portions 70b and constitute magnetic attraction plates 66.

As shown in FIG. 9, each of the lamination metal sheets 64 includes an arc-shaped frame portion 64a, a plurality of coil support portions 64b extending from the frame portion toward the center thereof, and arc-shaped locking portions 64c formed to the extending ends of the coil support portions integrally therewith. The frame portion 64a is formed to an arc shape from which a circumferential portion corresponding to a removed portion 63 is removed so that it is partially opened. In the second embodiment, the lamination metal sheets 64 are different from the base metal sheet 70 in that they are formed to a shape in which a portion corresponding to two coil support portions 64b is removed from the lamination metal sheets 64. The base metal sheet 70 and the lamination metal sheets 64 are formed of a magnetic material, for example, iron.

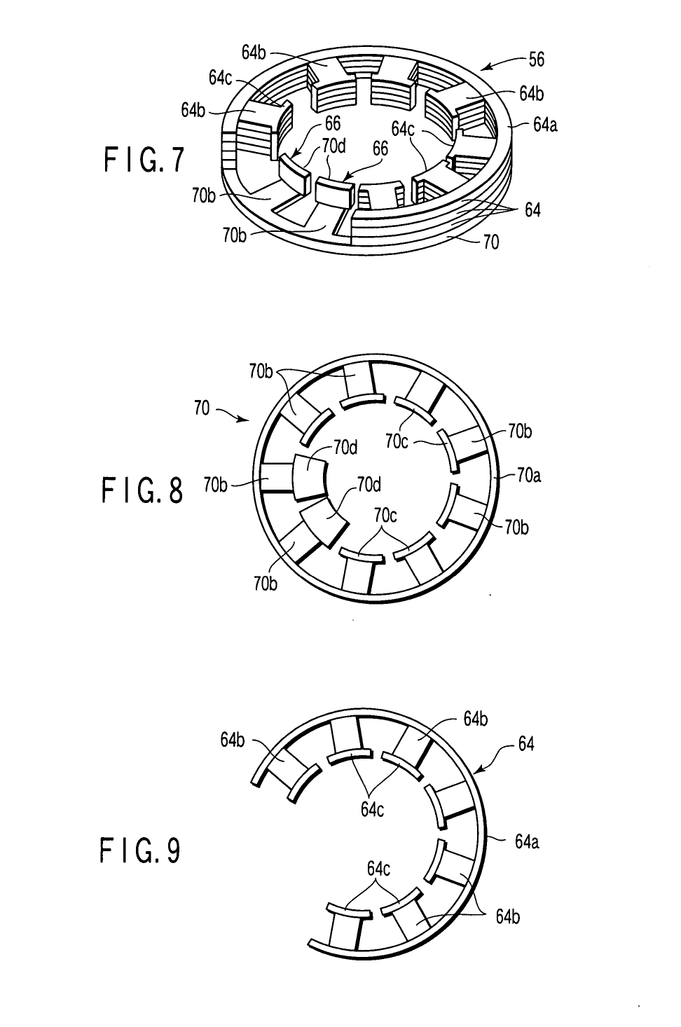

As shown in FIGS. 6 and 7, the core 56 is arranged by sequentially laminating the three lamination metal sheets 64 on the base metal sheet 70 in a state that the coil support portions 70b, 64b are overlapped in alignment. Only the extending portions 70d and the coil support portions 70b corresponding thereto in the base metal sheet 70 are located in the portion of the core 56 from which the lamination metal sheets 64 are removed and prescribe the removed portion 63. Further, the two extending portions 70d are bent upward at right angles with respect to the coil support portions 70b and form the magnetic attraction plate 66. The magnetic attraction plate 66 is formed to an arc-shape and arranged on the concentric circle of the locking portions 64c of the core 56 constituting the stator 50.

Coils 58 are wound around laminated members, which are formed of the coil support portions 70b of the base metal sheet 70 and the coil support portions 64b of the lamination metal sheets 64 except the coil support portions 70b to which the extending portions 70d are arranged. With this configuration, the stator 50 having a plurality of magnetic poles 60 is formed.

As shown in FIG. 6, the stator 50 is fixed on the base 11 coaxially with a spindle shaft 54 and confronts with the outside of a hub 52. The plurality of magnetic poles 60 of the stator 50 are arranged at equal intervals along the circumferential direction in confrontation with magnetic poles of a magnet 62. The magnetic attraction plate 66 is located in confrontation with the magnet 62 in the vicinity thereof. The removed portion 63 of the stator 50 is located on a moving path of magnetic heads 16.

Note that the removed portion 63 is formed to a range corresponding to 25% or less of the entire angle of 360° in the circumferential direction of the stator 50, that is, to a range corresponding to 90° or less. In the second embodiment, the removed portion 63 is formed in a range of, for example, 65° with respect to the entire circumference of 360° of the stator 50. Further, in the removed portion 63, a magnetic shield plate 68 is arranged by being overlapped to the outside surfaces of the base metal sheet 70 and the magnetic attraction plate 66.

In the second embodiment, since the other configuration of the HDD is the same as that of the first embodiment described above, the same components as those of the first embodiment are denoted by the same reference numerals, and the detailed description thereof is omitted.

The same operation and advantage as those of the first embodiment can be obtained also in the HDD according to the second embodiment configured as described above. Further, according to the second embodiment, the magnetic attraction plates are configured making use of a part of the core constituting the stator 50. For this reason, a base having the same structure as a conventional base can be used without applying any special processing to the base of a case. With this configuration, it is possible to reduce a manufacturing cost.

The present invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Further, components according to different embodiments may be combined as required.

For example, the present invention can be also applied to a disk apparatus having a disk diameter of, for example, 1 inch, 1.8 inches, and the like, in addition to a disk apparatus having a disk diameter of 0.85 inch. The numbers of the magnetic disks and the magnetic heads are not limited to those of the above embodiments and can be increased as necessary. Further, the materials of the respective components such as the case, the core, and the magnetic shield plate are not limited to those of the above embodiments and may be variously selected.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk apparatus comprising:
a case having a base;
a disk-shaped recording medium arranged in the case;
a drive motor which rotates the recording medium, the drive motor being arranged on the base and supporting the recording medium;
heads which record and replay information to and from the recording medium; and
a head actuator which moves the heads with respect to the recording medium, the head actuator being arranged in the case and movably supporting the heads,
the drive motor including:
a rotor having a plurality of magnetic poles arranged side by side in a circumferential direction;
a fluid bearing rotatably supporting the rotor; and
a stator arranged at an outer periphery of the rotor in a circumferential direction and having a plurality of magnetic poles in confrontation with the magnetic poles of the rotor, and
the stator including:
a removed portion which is located on a moving path of the heads and in which magnetic poles are removed in a range corresponding to 25% or less of the entire angle of 360° of the stator in the circumferential direction;
a plurality of stator magnetic poles arranged at intervals in the circumferential direction except the removed portion; and
a magnet attraction plate arranged in the removed portion and opposed to the rotor.

2. The disk apparatus according to claim 1, wherein the magnet attraction plate is formed by cutting and raising a part of the base.

3. The disk apparatus according to claim 1, wherein the stator comprises a core configured by laminating a plurality of metal sheets, and a plurality of coils wound around the core, and
the core includes a base metal sheet formed annularly and having extending portions constituting the magnet attraction plate; and a plurality of lamination metal sheets each of which is formed to an arc shape, in which a portion corresponding to the removed portion is removed, the lamination metal sheets being laminated on the base metal sheet.

4. The disk apparatus according to claim 1, wherein the drive motor includes a magnetic shield plate arranged on an outer peripheral side of the magnet attraction plate.

5. The disk apparatus according to claim 1, wherein the head actuator includes: a bearing unit supported on the base; and suspensions rotatably supported by the bearing unit and extending from the bearing unit to support the magnetic heads.

6. The disk apparatus according to claim 1, wherein the drive motor comprises:
a spindle shaft supported by the fluid bearing;
a hub fixed to the spindle shaft and constituting the rotor; and
an annular magnet fixed to the hub coaxially with the spindle shaft and constituting the plurality of magnetic poles, and
the recording medium is fixed to the hub and held coaxially with the spindle shaft.
